(19) United States
(12) Patent Application Publication
(10) Pub. No.: US 2003/0045310 A1
(43) Pub. Date: Mar. 6, 2003

(54) Status enquiry in a wireless communication system

(76) Inventor: Christopher David Price, Heathcote (GB)

Correspondence Address: MCGARRY BAIR LLP, 171 MONROE AVENUE, SUITE 600, GRAND RAPIDS, MI, 49503, US

(21) Appl. No.: 10/064,992

(22) Filed: Sep. 6, 2002

(30) Foreign Application Priority Data
Sep. 6, 2001 (GB) GB 0121639.9

(51) Int. Cl. H04M 3/42; H04Q 7/20; H04M 1/00; H04B 1/38

(52) U.S. Cl. 455/466; 455/566; 455/414

(57) ABSTRACT

A method of status enquiry between a plurality of subscriber communication units in a wireless communication system includes the step of transmitting (220) a status enquiry message from a first subscriber communication unit (100) to a second subscriber communication unit. The second subscriber communication unit receives said status enquiry message and transmits (240) a status response message back to said first subscriber communication unit in response to said status enquiry message. This provides an ability to a subscriber unit to determine the status of another subscriber unit without the need to initiate a full call set-up to that subscriber unit. This allows the user to automatically ascertain whether the destination subscriber unit is available before making the call. The destination subscriber unit may automatically respond without user input, and preferably without the need for the user to be informed.

### CROSS REFERENCE TO RELATED APPLICATIONS This application claims priority on British Patent Application GB 0121639.9 filed Sep. 6, 2001.

### BACKGROUND OF INVENTION

1. Field of the Invention

This invention relates to a method of ascertaining the status of a subscriber communication unit in a wireless communication system. The invention is applicable to, but not limited to, a method of ascertaining the status of one mobile server by another mobile server.

2. Background of the Invention

Wireless communication systems, for example cellular telephony or private mobile radio communication systems, typically provide for radio telecommunication links to be arranged between a plurality of base transceiver stations (BTSs) and a plurality of subscriber units.

In a wireless communication system, each BTS has associated with it a particular geographical coverage area (or cell). The coverage area is defined by a particular range where the BTS can maintain acceptable communications with mobile stations operating within its serving cell. Often these cells combine to produce an extensive coverage area.

Wireless communication systems are distinguished over fixed communication systems, such as the public switched telephone network (PSTN), principally in that mobile stations move between coverage areas served by different BTS (and/or different service providers) and, in doing so, encounter varying radio propagation environments.

In the field of wireless communications, it is known for portable or mobile communication units to operate as mobile servers. In the context of the present invention, the term “mobile server” (MS) is used to refer to the combination of a “subscriber communication unit” and a subscriber identity module (SIM) or at least an element that is capable of replicating the functions of a SIM. The subscriber communication unit in this context is the radio frequency (RF) transceiver hardware of a wireless communication unit that is used by the SIM to communicate to other communication units. The subscriber communication unit is physically capable of RF communication with a network, but without the SIM will be refused access to the network.

One problem with MSs is that it is possible for them to travel outside of a mobile cellular communication network, or that a MS can be switched off, thereby becoming uncontactable by other communication units in the communication system, either wireless portable/mobile products or other elements in the infrastructure, such as the serving BTS (or Node B).

One simple way of ascertaining whether or not a MS is contactable is to make a call to the MS. However, this is not always desirable. An example would be if a user's MS wishes to send a short message service (SMS) text message to another MS. If the user's MS is not configured for delivery reports to be returned, once the SMS message has been received, the user will not know whether the MS to which they are sending the SMS text message is contactable, and therefore whether the text message has been received.

Not all users of mobile servers desire delivery reports to be returned for each SMS text message they send. Therefore, on the occasions that they wish to have confirmation that the destination MS was contactable and received the SMS message, it is necessary for them to configure the MS to receive a delivery report for that particular SMS message. After receiving the delivery report, it is then necessary for the MS to reconfigure itself so that such delivery reports are no longer requested.

Furthermore, some network operators do not permit delivery reports to be returned, if they are unable to charge for the delivery reports. This is particularly the case if the network operator has to bear the transmittal costs of the delivery reports. Under such circumstances, the user cannot easily determine whether the destination MS is contactable and whether it received the SMS message.

The inventor of the present invention has recognized another situation where a user of a first MS might be interested in ascertaining an operational and/or contact-ability status of another MS. Such a situation would occur when the destination MS is contactable but the user of the destination MS does not respond or answer when a call is made. The inventor of the present invention has recognized the benefit for an MS user to have a means of informing another MS user who is trying to contact them that they are presently unavailable. In this way, the user attempting to make contact would not feel the necessity to repeatedly attempt to make contact, but rather wait until the user they are attempting to contact becomes available.

Thus, there exists a need in the field of the present invention to provide a means and method of providing a status enquiry wherein the abovementioned disadvantages associated with prior art arrangements may be alleviated.

### SUMMARY OF INVENTION

In accordance with a first aspect of the present invention, there is provided a method of status enquiry, as claimed in claim 1.

In accordance with a second aspect of the present invention, there is provided a wireless communication system, as claimed in claim 13.

In accordance with a third aspect of the present invention, there is provided a wireless communication unit, as claimed in claim 14.

In accordance with a fourth aspect of the present invention, there is provided a wireless communication unit, as claimed in claim 15.

In accordance with a fifth aspect of the present invention, there is provided a wireless communication unit, as claimed in claim 21.

In accordance with a sixth aspect of the present invention, there is provided a storage medium, as claimed in claim 26.

### BRIEF DESCRIPTION OF DRAWINGS

Exemplary embodiments of the present invention will now be described, with reference to the accompanying drawings, in which:

FIG. 1 shows a block diagram of a wireless communication unit such as a mobile server (MS) adapted to facilitate the use of status messages, in accordance with a preferred embodiment of the invention; and

FIG. 2 shows a flowchart illustrating a status enquiry and response process, in accordance with the preferred embodiment of the present invention.

### DETAILED DESCRIPTION

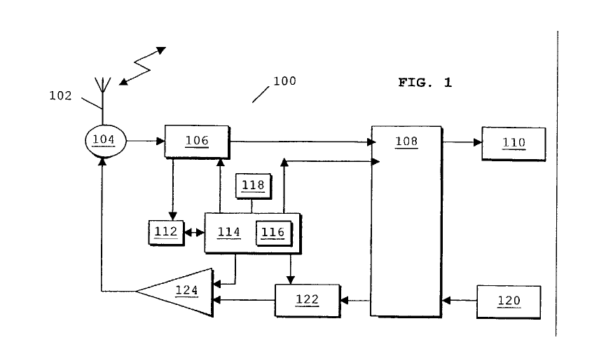

The present invention relates to a method of ascertaining the status of a mobile server (MS), for example a mobile cellular phone with a SIM. Referring now to FIG. 1, a block diagram of a wireless communication unit/mobile server (MS) is shown, in accordance with a preferred embodiment of the invention.

The MS 100 contains an antenna 102 preferably coupled to a duplex filter, circulator or antenna switch 104 that provides isolation between receive and transmit chains within the MS 100.

The receiver chain, as known in the art, includes scanning receiver front-end circuitry 106 (effectively providing reception, filtering and intermediate or base-band frequency conversion). The scanning front-end circuit is serially coupled to a signal processing function 108. An output from the signal processing function 108 is provided to a suitable output device 110, such as a screen or flat panel display.

The receiver chain also includes received signal strength indicator (RSSI) circuitry 112, which in turn is coupled to a controller 114 that maintains overall subscriber unit control. The controller 114 may therefore receive bit error rate (BER) or frame error rate (FER) data from recovered information. The controller 114 is also coupled to the scanning receiver front-end circuitry 106 and the signal processing function 108 (generally realized by a DSP).

SI The controller is also coupled to a memory device 116 that selectively stores operating regimes, such as decoding/encoding functions, synchronization patterns, code sequences, RSSI data, direction of arrival of a received signal and the like.

In accordance with the preferred embodiment of the invention, the memory device 116 stores status information relating to the MS's status enquiry preferences and/or those of other MS. Furthermore, a timer 118 is operably coupled to the controller 114 to control the timing of operations (transmission or reception of time-dependent signals) within the MS 100, particularly with regard to transmitting and/or responding to status enquiry messages, either automatically or in response to user input.

As regards the transmit chain, this essentially includes an input device 120, such as a keypad, coupled in series through transmitter/modulation circuitry 122 and a power amplifier 124 to the antenna 102. The transmitter/modulation circuitry 122 and the power amplifier 124 are operationally responsive to the controller 114, and as such are used in transmitting the status enquiry messages, and/or automatic responses, to other MS within the network.

The signal processor function 208 in the transmit chain may be implemented as distinct from the processor in the receive chain. Alternatively, a single processor 108 may be used to implement processing of both transmit and receive signals, as shown in FIG. 1. Clearly, the various components within the MS 100 can be realized in discrete or integrated component form, with an ultimate structure therefore being merely an arbitrary selection.

In accordance with the preferred embodiment of the present invention, scanning receiver front-end circuitry 106, together with, and under the control and guidance of, the signal processing function 108, memory device 116, timer function 118 and controller 114 have been adapted to receive and process status enquiry messages and/or associated status response messages.

Furthermore, in accordance with the preferred embodiment of the present invention, the transmitter/modulation circuitry 122, together with, and under the control and guidance of, the signal processing function 108, memory device 116, timer function 118 and controller 114 have been adapted to transmit and process status enquiry messages and/or associated status response messages.

In accordance with the preferred embodiment of the invention, the SIM may comprise a portion of, or the entire, memory device.

Preferably, the initiation of a status enquiry by an originating MS is effected in the simplest manner possible. For example, in order for the user of the originating MS to initiate the status enquiry, the user may access a phone book feature or call register feature stored in memory device 116, where the phone book feature or call register feature relates to the user's MS/SIM. The user may then locate the name/number corresponding to the desired destination MS by scrolling up/down the phone book, and select from the names/numbers displayed on the MS screen 110, as known in the art.

Furthermore, in the preferred embodiment of the present invention, a list of options are additionally provided in a menu accessible from the memory device 116 of the MS 100, under the control of controller 114 and/or processor function 108. The list of options includes a “Status” option. On selecting the “Status” option, the originating MS may transmit the status enquiry to a selected destination MS using, for example, the aforementioned phone book feature or call register feature.

Alternatively, the MS may have a menu option specifically for ascertaining the statuses of other MSs. When this option in the menu is selected, the user enters the number, or obtains the number from the phone book feature or call register feature of the MS from its memory device 116, in order to initiate the status enquiry.

It is within the contemplation of the invention that a further alternative method would be for the MS to include a dedicated button on, say, its keypad 120. The button, when pressed by the user, accesses the status enquiry feature of the MS. On entering the number of the destination MS, or selecting the number from the phone book feature or call register feature of the MS, the user can initiate the status enquiry.

Preferably, the status enquiry is transmitted in the form of a short message service (SMS) message, with the header of the SMS message identifying the message as being a status enquiry. However, it is within the contemplation of the invention that alternative message formats can be used.

It is also within the contemplation of the invention that the functionality of the controller 114 and/or processor 108 may be incorporated into, or distributed between, a number of elements, and need not be located solely in the either the controller 114 or processor 108.

More generally, an algorithm to initiate status enquiry messages or responses thereto, according to the preferred embodiment of the present invention may be implemented in a subscriber communication unit in any suitable manner. For example, new apparatus may be added to an existing subscriber communication unit, or alternatively existing parts of a conventional communication unit may be adapted, for example by reprogramming one or more processors therein. As such, the required adaptation may be implemented in the form of processor-implementable instructions stored on a storage medium, such as a floppy disk, hard disk, PROM, RAM or any combination of these or other storage multimedia.

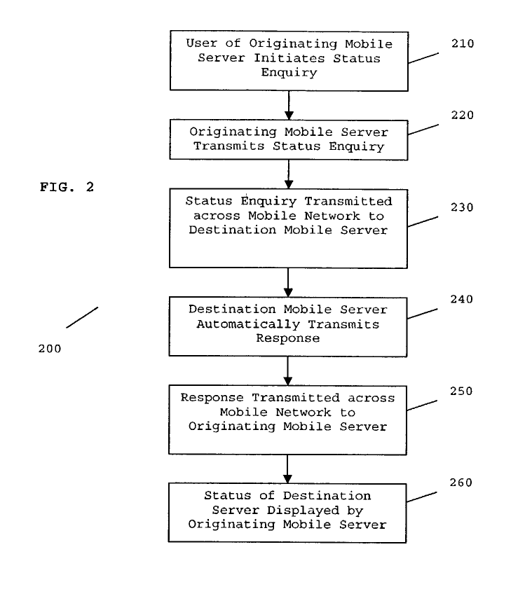

Referring now to FIG. 2, a flowchart 200 illustrates a status enquiry process in accordance with the preferred embodiment of the present invention.

In order for a user of a first, originating MS to ascertain the status of a second destination MS, the user of the originating MS initiates a status enquiry, as shown in step 210, for example using any of the techniques described with respect to FIG. 1. On initiation of the status enquiry, the originating MS transmits a status enquiry to a mobile network, such as a GSM network, as in step 220.

The status enquiry is then transmitted across the mobile network to the destination MS, as shown in step 230. Such a transmission may encompass a BTS (or Node B in UMTS parlance) receiving and forwarding the transmission directly to the destination MS, if the destination MS is also within its coverage area. Alternatively, such a transmission may encompass the messages being passed from the originating MS's serving BTS to the destination MS's serving BTS via a BSC (or radio network controller (RNC) in UMTS parlance), if the destination MS is not within its coverage area.

On receipt of the status enquiry, the destination MS automatically transmits a response back to the originating MS, as in step 240. This response is transmitted across the mobile network to the originating MS, as shown in step 250. On receipt of the response, the originating MS may display the operational and/or contact-ability status of the destination MS to its user, as shown in step 260.

In one embodiment of the present invention, on receipt of the status enquiry, the destination MS automatically transmits a response back to the originating MS. The transmitted response informs the originating MS that the message has been received. The destination MS may also display a message to its user stating that a status enquiry has been received.

It is envisaged that the user of the originating MS may not wish the user of the destination MS to know that they have automatically responded to the status enquiry. In this case, the header of the status enquiry message may include a flag that determines whether a presence of status enquiry message is to be indicated to a destination user, upon the destination user receiving a status enquiry message.

It is within the contemplation of the invention that all the aspects of the status enquiry procedure of the preferred embodiments of the invention may be user-configurable. One example would be for a user of the destination MS to configure their MS such that it only receives status enquiry calls at particular times of the day, or particular days in the week. Furthermore, a destination MS user may configure his/her MS in respect of whether or not a message should be displayed that informs the user that a status enquiry has been received.

The user of the destination MS may also provide information to be included in a response to a status enquiry. The response may therefore contain information such as: whether or not the user is available to accept calls, whether only priority calls will be received, when they will start accepting calls, etc.

In a further embodiment of the present invention, on receipt of the status enquiry, the destination MS may configure their MS to include status information in its response. For example, the status information may include whether the destination MS is set to play, for example, a ring tone on receiving a call, whether the MS is muted, or indeed any other form of set-up information.

If the destination MS is configured not to recognize status enquiry SMS messages, then the message is preferably treated like any other SMS message. The message may include a generic text string, such as “You have received a status enquiry”. In this way the destination MS, which does not recognize status enquiries, will treat it as a normal SMS text message, for which it will return a delivery report.

On receipt of the response, the originating MS preferably displays to the originating user a message stating that a response to the status enquiry had been received. In this manner, the user of the originating MS knows that the destination MS is contactable. It is within the contemplation of the invention that the originating MS may automatically display the message, or alternatively may simply inform the user that there is a message waiting to be read, and store the message for the user to read later.

If the destination MS is uncontactable, preferably a message from a network operator will be returned to the originating MS. The message informs the user of the originating MS that the destination MS is uncontactable.

It is also within the contemplation of the invention that the network operator may retain a copy of the status enquiry message. In this manner, when the destination MS subsequently becomes contactable, the status enquiry message can be transmitted to the destination MS and a response message returned to the originating MS. Thus, the user of the originating MS will know when the destination MS becomes available.

It is further envisaged that such status enquiry messages may be stored within any suitable element of the communication system's infrastructure, such as a base transceiver station (BTS) (or Node B in UMTS parlance), a base station controller (BSC) (or RNC in UMTS parlance), a mobile switching centre (MSC) or an operations and management centre (OMC).

A further embodiment of the present invention includes tagging entries in the phone book feature or call register feature of the originating MS. For those entries that are tagged, the MS may automatically transmit status enquiries either at specific times of the day, or periodically, such that the user of the MS can be kept informed as to the availability of the MSs corresponding to those entries tagged within the phone book feature or call register feature of the originating MS.

Alternatively, the user of the originating MS may need to phone a specific number at a certain time and/or day. The user may be able to set a reminder on the MS such that when it is time for the user to phone the specific number, the MS automatically reminds the user that they need to make the phone call. Such a reminder occurs whilst also the MS automatically transmits a status enquiry message to the desired destination MS to determine if the number they are required to call is contactable.

The preferred embodiment of the present invention is described with respect to a mobile server comprising a radio frequency interface to a wireless communication system, operably coupled to a user-specific memory module such as a SIM. However, it is within the contemplation of the invention that other wireless communication units, such as a cellular phone, personal digital assistant (PDA), portable radio, laptop computer, pager, etc. could benefit from the inventive concepts hereinbefore described.

It will be understood that the status enquiry means and method described above provides at least some of the following advantages:

(i) Provides the ability to determine the status of another mobile server (MS)/subscriber unit without the need to make a full call set-up to that MS/subscriber unit.

(ii) If the user has not configured their MS to receive delivery reports for SMS text messages, it is not necessary for them to change the configuration of their MS in order to ascertain whether the destination MS is contactable.

(iii) Even if a network operator does not permit delivery reports for SMS text messages, it is likely that they will permit the sending and responding to of status enquiries, as these will generate further revenue.

(iv) A user of a MS may initiate a status enquiry with the only input required being the phone number of the destination MS, or the location of the phone number of the destination MS within a phone book feature or call register feature of the MS.

(v) The destination MS automatically responds without user input, and possibly without the need for the user to be informed.

(vi) Certain embodiments of the present invention provide the advantage that a user of a destination MS can configure its status message handling in advance. Subsequently, whenever a status enquiry is received by that destination MS, the configured information is automatically included in the response by the MS.

(vii) Other embodiments of the present invention provide for an originating MS to transmit status enquiries at predetermined times, for example when the user has arranged to call the user of the destination MS. This allows the user to automatically ascertain whether the destination MS is available before initiating a full call set-up.

Whilst the specific and preferred implementations of the embodiments of the present invention are described above, it is clear that variations and modifications of such inventive concepts could be readily applied by one skilled in the art.

Thus, a status enquiry means and method have been described wherein the aforementioned disadvantages associated with prior art means and methods have been substantially alleviated.

1. A method of status enquiry between a plurality of subscriber communication units in a wireless communication system, the method comprising the steps of:
transmitting a status enquiry from a first subscriber communication unit to a second subscriber communication unit;
receiving said status enquiry at said second subscriber communication unit; and
transmitting a status response message back to said first subscriber communication unit in response to said status enquiry.

2. The method of status enquiry according to claim 1, wherein the step of transmitting a status response message is performed either automatically or in response to a second subscriber communication user input.

3. The method of status enquiry according to claim 1, the method further comprising the step of:
displaying at said first subscriber communication unit, upon receipt of the status response message, a status indication of said second subscriber communication unit.

4. The method of status enquiry according to claim 1, the method further comprising the step of:
displaying at said second subscriber communication unit, upon receipt of said status enquiry message, an indication that a status enquiry message has been received.

5. The method of status enquiry according to claim 1, the method further comprising the steps of:
transmitting said status enquiry message from said first subscriber communication unit via infrastructure in said wireless communication system to said second subscriber communication unit; and/or
transmitting said status response message from said second subscriber communication unit via infrastructure in said wireless communication system to said first subscriber communication unit.

6. The method of status enquiry according to claim 1, the method further comprising the step of:
providing a user of said second subscriber communication unit with an ability to input status information to be included in a response to a status enquiry message.

7. The method of status enquiry according to claim 1, wherein said status enquiry message is transmitted in the form of a short message service message.

8. The method of status enquiry according to claim 7, the method further comprising the step of:
identifying said status enquiry message as being a status enquiry in a header portion of said short message service message.

9. The method of status enquiry according to claim 1, the method further comprising the step of:
making a number of features of said status enquiry message or said status response message user-configurable.

10. The method of status enquiry according to claim 9, wherein said user-configurable features include at least one of:
(i) an ability to transmit or receive status enquiry calls at a particular time of a day, or a particular day in a week,
(ii) whether a status enquiry message and/or a status enquiry response should be displayed to a user,
(iii) whether a subscriber communication unit is accepting calls,
(iv) whether a subscriber communication unit is accepting priority calls,
(v) when a subscriber communication unit will start accepting calls,
(vi) whether a subscriber communication unit is arranged to play, for example, a ring tone on receiving a call, or
(vii) whether a subscriber communication unit is muted.

11. The method of status enquiry according to claim 1, the method further comprising the step of:
storing said status enquiry message and/or said status response message in either an element in the infrastructure of said wireless communication system for subsequent re-transmittal to a requesting or destination subscriber unit or in said first or second subscriber communication unit for subsequent retrieval by a user.

12. The method of status enquiry according to claim 1, the method further comprising the step of:
tagging at least one phonebook entry or call register relating to said status enquiry message such that it can be transmitted at a time of a day, or periodically, to allow a user to be kept informed as to the availability of at least one other subscriber communication unit.

13. A wireless communication system adapted to facilitate the status enquiry method steps of claim 1.

14. A subscriber communication unit adapted to perform any of the method steps of claim 1.

15. A subscriber communication unit comprising:
a controller for controlling transmission or reception of a status enquiry message or a status response message; and
a transmitter circuit, operably coupled to said controller, transmitting a status enquiry message or a status response message to another wireless remote communication unit.

16. A subscriber communication unit according to claim 15, the subscriber communication unit further comprising:
a controller for controlling transmission or reception of a status enquiry message or a status response message; and
a receiver circuit, operably coupled to said controller, receiving said status enquiry message or a status response message from another wireless remote communication unit.

17. The subscriber communication unit according to claim 15, the subscriber communication unit further comprising:
a memory device storing status information relating to at least one other subscriber communication unit.

18. The subscriber communication unit according to claim 17, wherein the memory device stores a phone book feature or call register feature related to said or at least one other subscriber communication unit that a user of said subscriber communication unit may access.

19. The subscriber communication unit according to claim 17, wherein the memory device stores a list of options in a menu accessible from said memory device, wherein said list of options includes a status enquiry option to initiate said status enquiry message.

20. The subscriber communication unit according to claim 15, wherein the subscriber communication unit is one of: a cellular phone, a portable or mobile radio, a personal digital assistant or a laptop computer.

21. A subscriber communication unit, comprising:
a controller for controlling transmission or reception of a status enquiry message or a status response message; and
a receiver circuit, operably coupled to said controller, receiving said status enquiry message or a status response message from another wireless remote communication unit.

22. he subscriber communication unit according to claim 21, the subscriber communication unit further comprising:
a memory device storing status information relating to at least one other subscriber communication unit.

23. The subscriber communication unit according to claim 22, wherein the memory device stores a phone book feature or call register feature related to said or at least one other subscriber communication unit that a user of said subscriber communication unit may access.

24. The subscriber communication unit according to claim 22, wherein the memory device stores a list of options in a menu accessible from said memory device, wherein said list of options includes a status enquiry option to initiate said status enquiry message.

25. The subscriber communication unit according to claim 21, wherein the subscriber communication unit is one of: a cellular phone, a portable or mobile radio, a personal digital assistant or a laptop computer.

26. A storage medium storing processor-implementable instructions for controlling a processor to carry out the method of claim 1.
